(19) United States
(12) Patent Application Publication
(10) Pub. No.: US 2025/0052518 A1
(43) Pub. Date: Feb. 13, 2025

(54) HEAT EXCHANGER AND METHOD FOR MANUFACTURING SAME

(71) Applicant: S PLUS COMTECH CO., LTD., Seoul (KR)

(72) Inventors: Dong Soo SHIN, Gwangmyeong-si, Gyeonggi-do (KR); Sangho KIM, Incheon (KR)

(73) Assignee: S PLUS COMTECH CO., LTD., Seoul (KR)

(21) Appl. No.: 18/851,136

(22) PCT Filed: Mar. 22, 2023
(86) PCT No.: PCT/KR2023/003783

§ 371 Date: Sep. 26, 2024

(30) Foreign Application Priority Data
Mar. 30, 2022 (KR) 10-2022-0039324
Dec. 15, 2022 (KR) 10-2022-0175568

(51) Int. Cl. F28F 1/24; B21D 53/08

(52) U.S. Cl. CPC F28F 1/24; B21D 53/08

(57) ABSTRACT

Provided, according to the present invention, is a heat exchanger including: a pipe structure having an inlet and an outlet formed therein and providing a flow path which is extended between the inlet and the outlet and through which a refrigerant flows; and a heat dissipation structure coupled to the pipe structure to exchange heat between the refrigerant and an external fluid, wherein the heat dissipation structure is made of a composite material comprising a resin material and a carbon material.

### TECHNICAL FIELD

The present invention relates to a heat exchanger, and more particularly, to a heat exchanger including a refrigerant pipe in which a refrigerant flows and a plurality of plate-shaped heat dissipation fins coupled to the refrigerant pipe, and a method for manufacturing the heat exchanger.

### BACKGROUND ART

As the background art related to a heat exchanger having a refrigerant pipe in which a refrigerant flows and a plurality of plate-shaped heat dissipation fins coupled to the refrigerant pipe, Korean Patent Laid-open Publication No. 10-2000-0066528 discloses a configuration in which a copper pipe in which a refrigerant flows is inserted into a plurality of fins that are perforated aluminum sheets and then the pipe is extended by a mechanical force or hydraulic pressure and the pipe is in close contact with the fins. However, such a heat exchanger according to the related art requires pipe extension and surface treatment on a metal fin such as anodizing etc., and thus, a manufacturing process is complicated.

### DETAILED DESCRIPTION OF THE INVENTION

### Technical Problem

The present invention provides a heat exchanger including a refrigerant pipe that is being easily manufactured and a plurality of plate-shaped heat dissipation fins coupled to the refrigerant pipe, and a method for manufacturing the heat exchanger.

### Technical Solution

According to an aspect of the present invention, there is provided a heat exchanger including: a pipe structure having an inlet and an outlet formed therein and providing a flow path which is extended between the inlet and the outlet and through which a refrigerant flows; and a heat dissipation structure coupled to the pipe structure to exchange heat between the refrigerant and an external fluid, wherein the heat dissipation structure is made of a composite material including a resin material and a carbon material.

According to another aspect of the present invention, there is provided a method for manufacturing a heat exchanger, the heat exchanger including a pipe structure having an inlet and an outlet formed therein and providing a flow path which is extended between the inlet and the outlet and through which a refrigerant flows and a heat dissipation structure coupled to the pipe structure to exchange heat between the refrigerant and an external fluid, the method including: a mold preparation operation in which a first mold and a second mold are prepared to be combined with each other and to form a cavity corresponding to a shape of the heat dissipation structure; an insert installation operation in which, before the first mold and the second mold are combined with each other, an insert including at least a part of the heat dissipation structure is installed in the middle corresponding to the cavity; a mold-combining operation in which the first mold and the second mold are combined with each other to form the cavity and the insert is disposed in the cavity; and an injection fluid injection operation in which an injection fluid is injected into the cavity, wherein the injection fluid includes a liquid resin material including a carbon material.

According to another aspect of the present invention, there is provided a method for manufacturing a heat exchanger, the method including: a heat dissipation structure preparation operation in which a heat dissipation structure made of a composite material including a resin material and a carbon material is prepared; an electrode assembly operation in which a first electrode and a second electrode are assembled to the heat dissipation structure; a tube assembly operation in which a main pipe portion on which a fluid to be heat-exchanged flows, is assembled to the heat dissipation structure; and a tube expansion operation in which the main pipe portion is plastically deformed to be expanded, wherein the tube assembly operation is performed by inserting the main pipe portion into a tube path formed on the heat dissipation structure, and the tube expansion operation is performed by injecting a high-pressure air into the main pipe portion.

According to another aspect of the present invention, there is provided a method for manufacturing a heat exchanger, the method including: a heat dissipation structure preparation operation in which a heat dissipation structure made of a composite material including a resin material and a carbon material is prepared; an electrode preparation operation in which a first electrode and a second electrode are prepared; a tube preparation operation in which a main pipe portion on which a fluid to be heat-exchanged flows is prepared; an electrode assembly operation in which the first electrode and the second electrode are assembled to the heat dissipation structure; a tube assembly operation in which the main pipe portion is assembled to the heat dissipation structure; and a room temperature maintenance operation in which the first electrode, the second electrode and the main pipe portion are maintained at room temperature while they are assembled to the heat dissipation structure, wherein, in the heat dissipation structure preparation operation, the heat dissipation structure is high-temperature treated and is prepared in an expanded state, and in the electrode preparation operation, the first electrode and the second electrode are low-temperature treated and are prepared in a contracted state, and in the tube preparation operation, the main pipe portion is low-temperature treated and is prepared in a contracted state, and the electrode assembly operation is performed by inserting the first electrode and the second electrode into a first electrode path and a second electrode path formed on the heat dissipation structure, respectively, and the tube assembly operation is performed by inserting the main pipe portion into a tube path formed on the heat dissipation structure, and in the room temperature maintenance operation, the heat dissipation structure is contracted into an original state, and the first electrode, the second electrode, and the main pipe portion are contracted into original states.

### Effects of the Invention

According to the present invention, all of the objectives of the present invention described above can be achieved. Specifically, since a heat dissipation structure coupled to a pipe structure to exchange heat between a refrigerant flowing through the pipe structure and an external fluid is made of a composite material including a resin material and a carbon material, manufacturing can be easily performed through insert injection molding.

In addition, since the pipe structure is inserted into and assembled to a tube path formed on the heat dissipation structure made of a composite material including a resin material and a carbon material and a high-pressure gas is injected into the pipe structure to extend the pipe structure and the pipe structure and the heat dissipation structure are in close contact with each other and are coupled to each other, manufacturing of the heat exchanger can be easily performed.

Furthermore, after the pipe structure that is treated at a low temperature and contracted is inserted into the tube path formed on the heat dissipation structure in a state in which the heat dissipation structure made of a composite material including a resin material and a carbon material is treated at a high temperature and expanded, the pipe structure is maintained in a room temperature state and is contracted into an original state, and the pipe structure is expanded in an original state and thus the pipe structure and the heat dissipation structure are in close contact with each other and coupled to each other, manufacturing of the heat exchanger can be easily performed.

### DESCRIPTION OF THE DRAWINGS

FIG. 1 is a perspective view of a heat exchanger according to an embodiment of the present invention.

FIG. 2 is a cross-sectional view of a heat dissipation structure of the heat exchanger shown in FIG. 1, taken along a line A-A′ of FIG. 1.

FIG. 3 is a cross-sectional view of a heat dissipation structure of the heat exchanger shown in FIG. 1, taken along a line B-B′ of FIG. 1.

FIG. 4 is a cross-sectional view of a heat dissipation structure of a heat exchanger according to another embodiment of the present invention.

FIG. 5 is a cross-sectional view of a heat dissipation structure of a heat exchanger according to another embodiment of the present invention.

FIG. 6 is a perspective view of a heat dissipation structure of a heat exchanger according to another embodiment of the present invention.

FIG. 7 is a flowchart schematically illustrating a method for manufacturing a heat exchanger according to an embodiment of the present invention.

FIG. 8 is a view for describing a mold preparation operation and an insert installation operation of FIG. 7.

FIG. 9 is a view describing a state in which a mold-combining operation of FIG. 7 is performed.

FIGS. 10 and 11 are views describing a state in which an injection fluid injection operation of FIG. 7 is performed.

FIG. 12 is a perspective view of a heat exchanger according to another embodiment of the present invention.

FIG. 13 is a cross-sectional view of a heat dissipation structure of the heat exchanger shown in FIG. 1, taken along a line C-C′ of FIG. 12.

FIG. 14 is an exploded perspective view of the heat exchanger shown in FIG. 12.

FIG. 15 is a plan view of a unit heat dissipation body of the heat exchanger shown in FIG. 12.

FIG. 16 is a perspective view of a heat exchanger according to another embodiment of the present invention.

FIG. 17 is a flowchart schematically illustrating a method for manufacturing a heat exchanger according to another embodiment of the present invention.

FIG. 18 is a view showing a state in which an electrode assembly operation of FIG. 17 is performed.

FIG. 19 is a view showing a state in which a tube assembly operation of FIG. 17 is performed.

FIG. 20 is a view showing a state in which an additional assembly operation of FIG. 17 is performed.

FIG. 21 is a flowchart schematically illustrating a method for manufacturing a heat exchanger according to another embodiment of the present invention.

### MODE OF THE INVENTION

Hereinafter, the configuration and operation of embodiments of the present invention will be described in detail with reference to the drawings.

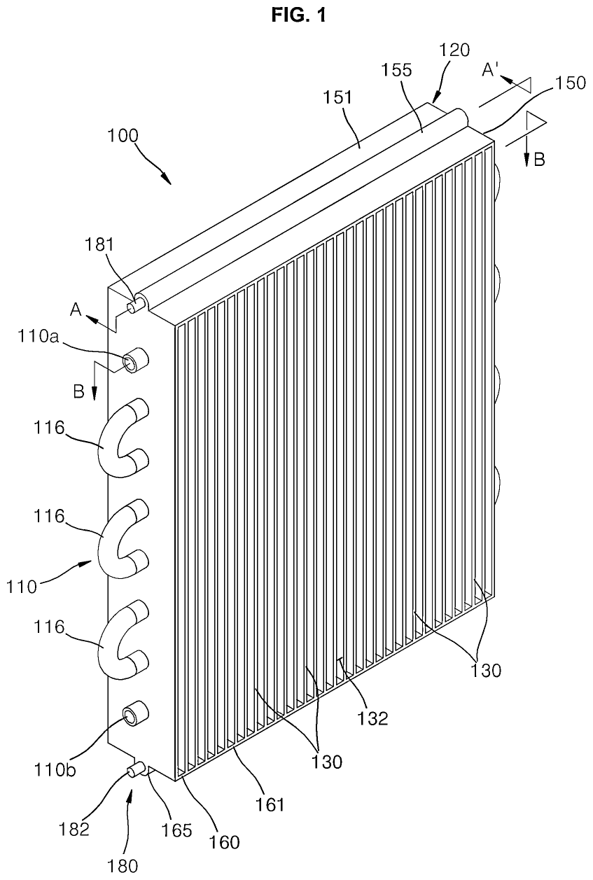

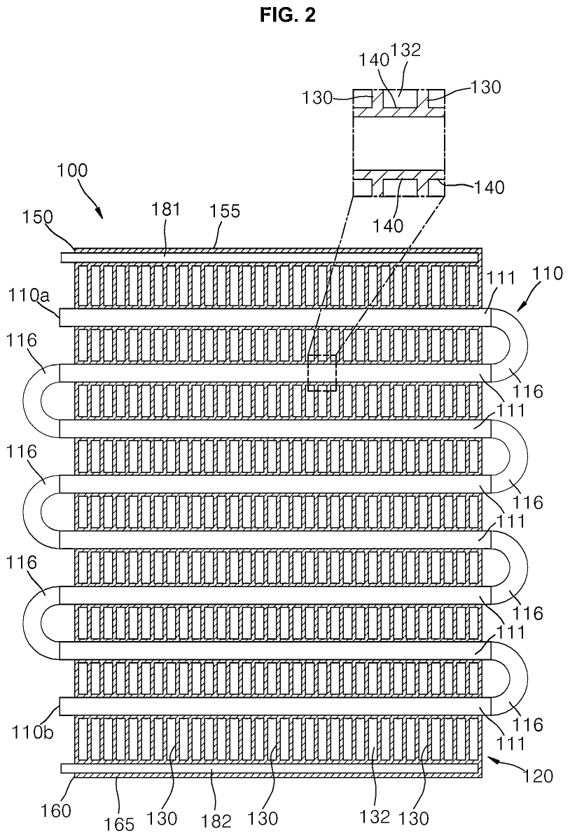

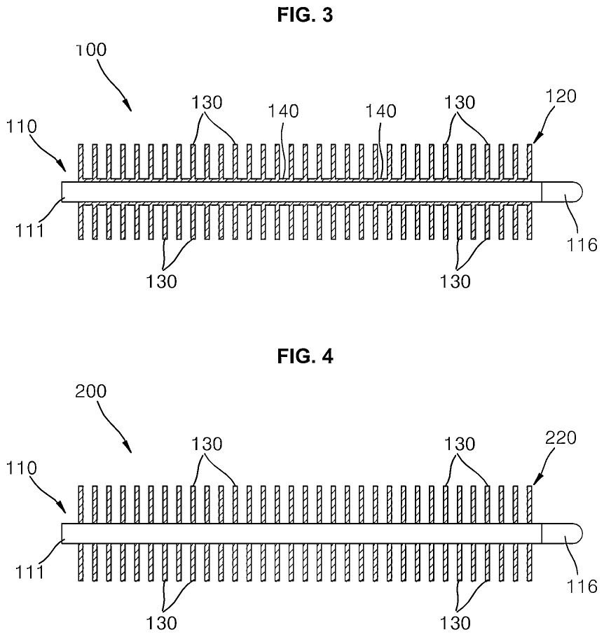

FIG. 1 is a perspective view of a heat exchanger according to an embodiment of the present invention. Referring to FIG. 1, a heat exchanger 100 according to an embodiment of the present invention includes a pipe structure 110, a heat dissipation structure 120 coupled to the pipe structure 110, and an electrode structure 180 installed in the heat dissipation structure 120. FIG. 2 is a cross-sectional view of the heat dissipation structure 120 of the heat exchanger 100 shown in FIG. 1, taken along a line A-A′ of FIG. 1. FIG. 3 is a cross-sectional view of the heat dissipation structure 120 of the heat exchanger 100 shown in FIG. 1, taken along a line B-B′ of FIG. 1. The main feature of the present invention is that the heat dissipation structure 120 of the heat exchanger 100 is made of a composite material including a resin and a carbon material.

Referring to FIGS. 1, 2, and 3, the pipe structure 110 includes a plurality of main pipe portions 111 that are extended generally in a straight line and are arranged in parallel, and connection pipe portions 116 that connect two adjacent main pipe portions 111 among the plurality of main pipe portions 111. The pipe structure 110 forms one flow path, and a fluid to be cooled by a heat exchanger such as a refrigerant flows through the pipe structure 110. Both ends in an extension direction of the pipe structure 110 form a refrigerant inlet 110a and a refrigerant outlet 110b, respectively. In the present embodiment, it will be described that the pipe structure 110 is copper pipe made of a copper material having excellent thermal conductivity generally used in the heat exchanger, but the present invention is not limited thereto.

Each of the plurality of main pipe portions 111 is extended generally in a straight line. The plurality of main pipe portions 111 are located to be arranged generally in parallel with each other on one plane. Two adjacent main pipe portions 111 among the plurality of main pipe portions 111 are connected to each other by the connection pipe portions 116 at an adjacent end thereof and communicate with each other. The plurality of main pipe portions 111 are combined with the heat dissipation structure 120. Heat of the refrigerant flowing through the plurality of main pipe portions 111 is transferred to the heat dissipation structure 120 via the plurality of main pipe portions 111.

Each of the plurality of connection pipe portions 116 connects two adjacent main pipe portions 111 among the plurality of main pipe portions 111 to each other and allows the two adjacent main pipe portions 111 to communicate with each other. The connection pipe portions 116 have generally a ‘U’ shape, and both ends of the connection pipe portions 116 are connected to two adjacent ends of each of the two adjacent main pipe portions 111.

In the present embodiment, it will be described that the whole of the plurality of main pipe portions 111 and the whole of the plurality of connection pipe portions 116 are respectively separately manufactured and the plurality of connection pipe portions 116 are combined to the plurality of main pipe portions 111 through a method such as welding and constitute the pipe structure 110. In this case, the main pipe portions 111 are formed by a first pipe extended generally in a straight line, and the connection pipe portions 116 are formed by a second pipe having generally a ‘U’ shape. The pipe structure 110 may be formed through another method, for example, one pipe material may be formed through bending processing. Unlike this, one pipe material is formed as a unit pipe portion (for example, a shape in which two main pipe portions are connected to each other by one connection pipe portion) having at least one connection pipe portion, and a plurality of unit pipe portions are connected to each other by the separately-manufactured connection pipe portions 116 so that the pipe structure 110 may also be formed.

The heat dissipation structure 120 is coupled to the heat structure 110 and dissipates heat of the refrigerant flowing through the pipe structure 110. Heat exchanging between heat of the refrigerant flowing through the pipe structure 110 and air around the heat dissipation structure 120 is performed through the heat dissipation structure 120. The heat dissipation structure 120 is made of a composite material including generally a resin material and a carbon material. The carbon material of the composite material that constitutes the material of the heat dissipation structure 120 includes at least one of carbon fiber, carbon nanotube, and graphene. The carbon material of the composite material is distributed into the resin material and forms an electrical network. The length of the carbon material is 1 to 100 μm, and the content of carbon materials is 5 w % or more and 25 w % or less so as to form the electrical network. It will be described that carbon nanotube (CNT) is used for the carbon material. The composite material that constitutes the heat dissipation structure 120 may further include an additive such as a metal powder for improving thermal conductivity. The additive is interposed between carbon materials, increases the electrical network by the carbon materials and simultaneously increases thermal conductivity of the heat dissipation structure 120. In the present embodiment, the additive is a metal powder and has a diameter of 10 nm to 100 nm, and the content of the metal powder is 12 w % or more so as to increase the electrical network between the carbon materials and to increase thermal conductivity of the composite material and 30 w % or less so as to reduce the weight of the composite material. In the present embodiment, it will be described that an aluminum powder is used for the additive, will be described.

The heat dissipation structure 120 includes a plurality of heat dissipation fin portions 130, a plurality of pipe combination portions 140 that connect two adjacent heat dissipation fin portions 130 to each other while surrounding the plurality of main pipe portions 111 of the pipe structure 110, a first connection portion 150 to be connected together with the plurality of heat dissipation fin portions 130, and a second connection portion 160 to be connected together with the plurality of heat dissipation fin portions 130.

Each of the plurality of heat dissipation fin portions 130 is a plate-shaped bar shape that is extended long in an arrangement direction (a vertical direction in FIG. 1) of the plurality of main pipe portions 111 of the pipe structure 110. Each of the plurality of heat dissipation fin portions 130 is arranged to form generally a right angle to the extension direction of the main pipe portion 111 of the pipe structure 110. The plurality of heat dissipation fin portions 130 are sequentially arranged in a line in the extension direction of the main pipe portion 111 of the pipe structure 110. Thus, that is, the main pipe portion 111 of the pipe structure 110 penetrates the heat dissipation fin portion 130 at generally a right angle. Each of the plurality of heat dissipation fin portions 130 is spaced apart from another adjacent heat dissipation fin portion 130 so that a path 132 through which the air may flow, is formed between two adjacent heat dissipation fin portions 130. Heat exchanging between heat of the refrigerant flowing through the pipe structure 110 and the air flowing through the path 132 is performed by the heat dissipation fin portion 130. Each of the plurality of main pipe portions 111 of the pipe structure 110 passes each of the plurality of heat dissipation fin portions 130 so as to form generally a right angle to each other. The heat dissipation fin portion 130 is in close contact with an outer circumferential surface of the main pipe portion 111 at a portion coupled to the main pipe portion 111 of the pipe structure 110. Two adjacent heat dissipation fin portions 130 among the plurality of heat dissipation fin portions 130 are structurally connected to each other by the plurality of pipe combination portions 140. A first end (upper end in FIG. 1) in a lengthwise direction of each of the plurality of heat dissipation fin portions 130 is structurally connected by the first connection portion 150. A second end (lower end in FIG. 1) in the lengthwise direction of each of the plurality of heat dissipation fin portions 130 is structurally connected by the second connection portion 160. In the present embodiment, it will be described that the heat dissipation fin portion 130 has a flat plate shape, will be described, however, unlike this, the heat dissipation fin portion 130 may have a shape with a curvature in which at least a part of the heat dissipation fin portion 130 can be injected, and this also belongs to the scope of the present invention.

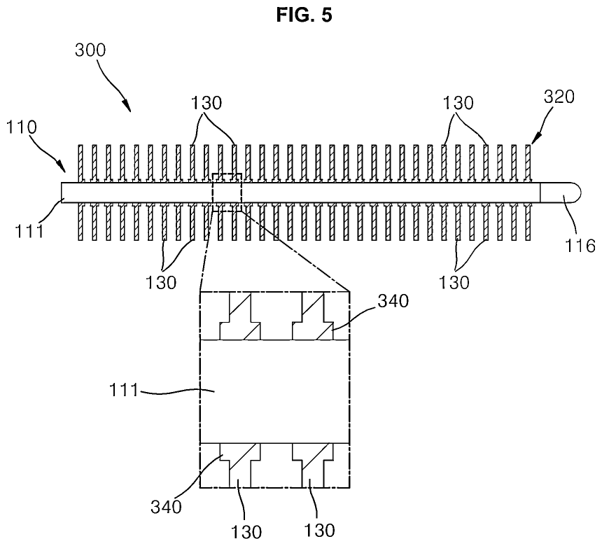

Each of the plurality of pipe combination portions 140 connects two adjacent heat dissipation fin portions 130 structurally while surrounding the plurality of main pipe portions 111 of the pipe structure 110. The plurality of pipe combination portions 140 are integrally connected to the two adjacent heat dissipation fin portions 130 and are in close contact with the outer circumferential surface of the main pipe portion 111 of the pipe structure 110 so that combination between the pipe structure 110 and the heat dissipation structure 120 becomes stronger and heat transfer from the pipe structure 110 to the heat dissipation structure 120 can be efficiently performed. In the present embodiment, it will be described that the pipe structure 110 is not exposed from the heat dissipation structure 120 by the pipe combination portion 140, however, unlike this, a heat exchanger 200 may include a heat dissipation structure 220 in which no pipe combination portion (140 of FIG. 3) is formed, as shown in FIG. 4, or a heat exchanger 300 may include a pipe combination portion 340 in which a heat dissipation structure 320 of the heat exchanger 300 is extended short, as shown in FIG. 5, so that the pipe structure 110 can be exposed between two adjacent heat dissipation fin portions 130, and this also belongs to the scope of the present invention.

The first connection portion 150 is connected to the first end (upper end in FIG. 1) in the lengthwise direction of each of the plurality of heat dissipation fin portions 130. The first connection portion 150 is structurally integrally connected to the plurality of heat dissipation fin portions 130. An electrode structure 180 is installed at the first connection portion 150. The first connection portion 150 includes a first connection plate 151 having a plate-shaped bar shape and connecting and generally covering the first end in the lengthwise direction of each of the plurality of heat dissipation fin portions 130, and a first electrode installation portion 155 that protrudes from an outer surface of the first connection plate 151 and is formed.

The first connection plate 151 has a plate-shaped bar shape and is extended long in the lengthwise direction of the main pipe portion 111. The first connection plate 151 is connected to the first end (upper end in FIG. 1) in the lengthwise direction of each of the plurality of heat dissipation fin portions 130. The first connection plate 151 covers the entire first end (upper end in FIG. 1) in the lengthwise direction of each of the plurality of heat dissipation fin portions 130. The first electrode installation portion 155 protrudes from the outer surface of the first connection plate 151 and is formed.

The first electrode installation portion 155 protrudes from the outer surface of the first connection plate 151, is formed integrally with the first connection plate 151 and is extended long in the shape of a belt in the lengthwise direction of the first connection plate 151. The first electrode installation portion 155 is located in the center of generally a widthwise direction of the first connection plate 151. An electrode structure 180 is installed at the first electrode installation portion 155. In the present embodiment, it will be described that the first electrode installation portion 155 protrudes from the outer surface of the first connection plate 151 and is formed, however, unlike this, although not shown, the first electrode installation portion 155 may protrude from an inner surface of the first connection plate 151 and may be formed inside, and this also belongs to the scope of the present invention.

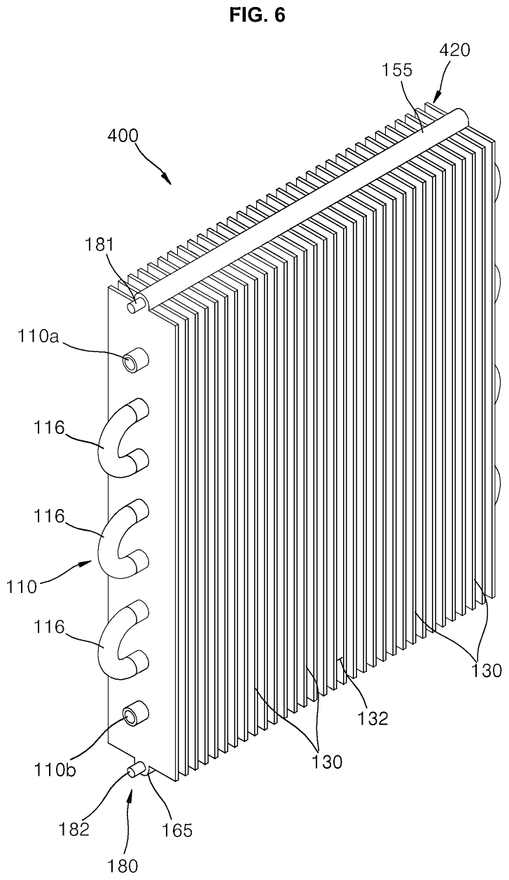

In the present embodiment, it will be described that the first connection portion 150 includes the first connection plate 151 and the first electrode installation portion 155, however, unlike this, the first connection portion 150 may include only the first electrode installation portion 155 without the first connection plate 151. This configuration shows a heat dissipation structure 420 of a heat exchanger 400 according to an embodiment shown in FIG. 6. As shown in FIG. 6, the first electrode installation portion 155 is in direct contact with the first end (upper end in FIG. 1) in the lengthwise direction of each of the plurality of heat dissipation fin portions 130 and is connected thereto.

Referring to FIGS. 1 through 3, the second connection portion 160 is connected to the second end (lower end in FIG. 1) in the lengthwise direction of each of the plurality of heat dissipation fin portions 130. The second connection portion 160 is structurally integrally connected to the heat dissipation fin portions 130. The electrode structure 180 is installed at the second connection portion 160. The second connection portion 160 includes a second connection plate 161 having a plate-shaped bar shape and connecting and generally covering a second end in the lengthwise direction of each of the plurality of heat dissipation fin portions 130, and a second electrode installation portion 165 that protrudes from the outer surface of the second connection plate 161 and is formed.

The second connection plate 161 has a plate-shaped bar shape and is extended long in the lengthwise direction of the main pipe portion 111. The second connection plate 161 is connected to the second end (lower end in FIG. 1) in the lengthwise direction of each of the plurality of heat dissipation fin portions 130. The second connection plate 161 covers the entire second end (lower end in FIG. 1) in the lengthwise direction of each of the plurality of heat dissipation fin portions 130. The second electrode installation portion 165 protrudes from the outer surface of the second connection plate 161 and is formed.

The second electrode installation portion 165 protrudes from the outer surface of the second connection plate 161, is formed integrally with the second connection plate 161 and is extended long in the shape of a belt in the lengthwise direction of the second connection plate 161. The second electrode installation portion 165 is located in the center of generally a widthwise direction of the second connection plate 161. The electrode structure 180 is installed at the second electrode installation portion 165. In the present embodiment, it will be described that the second electrode installation portion 165 protrudes from the outer surface of the second connection plate 161 and is formed, however, unlike this, although not shown, the second electrode installation portion 165 may protrude from the inner surface of the second connection plate 161 and may be formed inside, and this also belongs to the scope of the present invention.

In the present embodiment, it will be described that the second connection portion 160 includes the second connection plate 161 and the second electrode installation portion 165, however, unlike this, the second connection portion 160 may include only the second electrode installation portion 165 without the second connection portion 161. This configuration shows the heat dissipation structure 420 of the heat exchanger 400 according to the embodiment shown in FIG. 6. As shown in FIG. 6, the second electrode installation portion 165 is in direct contact with the second end (lower end in FIG. 1) in the lengthwise direction of each of the plurality of heat dissipation fin portions 130 and is connected thereto.

The electrode structure 180 includes a first electrode 181 and a second electrode 182. The first electrode 181 has the shape of a line or rod having electrical conductivity that is extended long and is buried in the first electrode installation portion 155 of the heat dissipation structure 120 and is installed. The first electrode 181 is extended long in the lengthwise direction of the first electrode installation portion 155. One end of the first electrode 181 is exposed to the outside of the first electrode installation portion 155. The second electrode 182 has the shape of a line or rod having electrical conductivity that is extended long and is buried in the second electrode installation portion 165 of the heat dissipation structure 120 and is installed. The second electrode 182 is extended long in the lengthwise direction of the second electrode installation portion 165. A voltage difference between the first electrode 181 and the second electrode 182 is generated by an external power, and due to the voltage difference between the first electrode 181 and the second electrode 182, the heat dissipation structure 120 dissipates heat, and frost attached to the heat dissipation structure 120 may be melted and removed in a refrigerant cooling process of the heat exchanger 100.

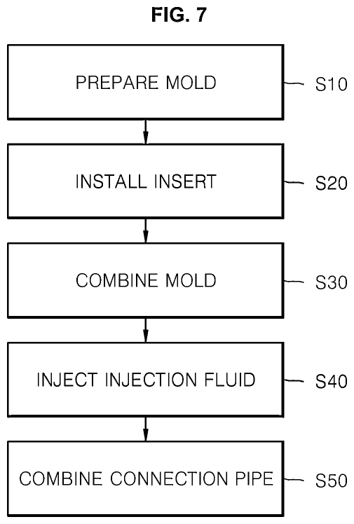

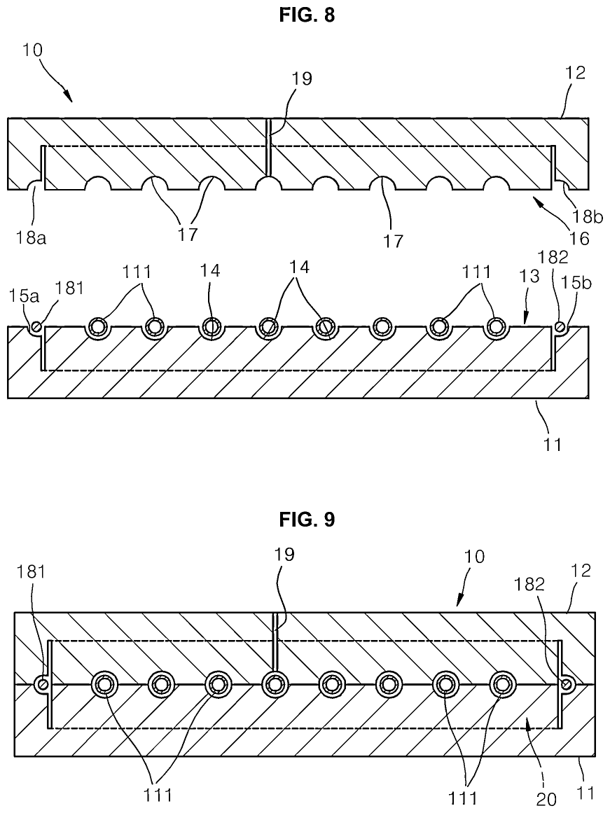

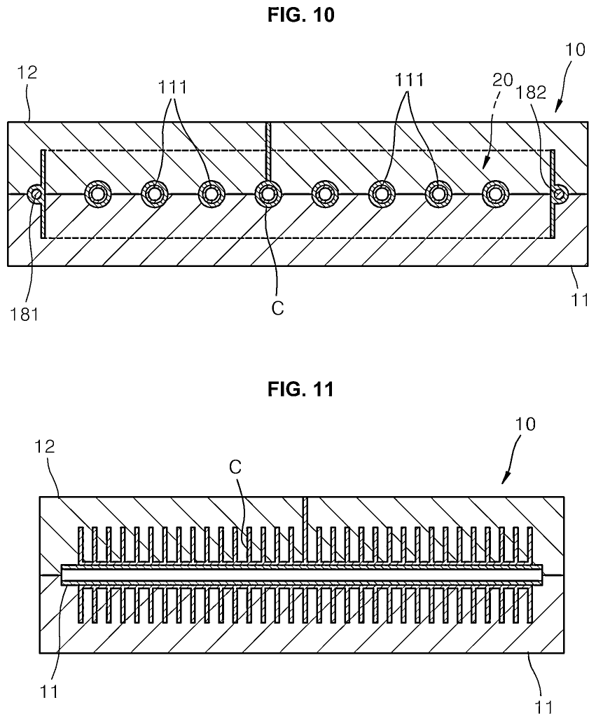

FIG. 7 is a flowchart schematically illustrating a method for manufacturing a heat exchanger according to an embodiment of the present invention, FIG. 8 is a view for describing a mold preparation operation and an insert installation operation of FIG. 7, FIG. 9 is a view describing a state in which a mold-combining operation of FIG. 7 is performed, and FIGS. 10 and 11 are views describing a state in which an injection fluid injection operation of FIG. 7 is performed.

Referring to FIG. 7, the method for manufacturing a heat exchanger according to an embodiment of the present invention that is used to manufacture a heat exchanger having the configuration shown in FIGS. 1 through 3, includes a mold preparation operation (S10) in which a mold is prepared, an insert installation operation (S20) in which an insert is installed into the mold prepared in the mold preparation operation (S10), a mold-combining operation (S30) in which combination of the mold is performed in a state in which the insert is installed in the mold through the insert installation operation (S20) to form a cavity in the mold, and an injection fluid injection operation (S40) in which an injection fluid is injected into the cavity formed by performing the mold-combining operation (S30).

In the mold preparation operation (S10), a mold for manufacturing the heat exchanger 100 using an insert injection molding method is prepared in a separated state. Referring to FIG. 8, a mold 10 includes a first mold 11 disposed below, and a second mold 12 disposed above. A first molding space 13 is formed in the first mold 11 to face the second mold 12. A plurality of first pipe arrangement grooves 14 having a trench groove shape in which the plurality of main pipe portions 111 are respectively arranged, a first-A electrode arrangement groove 15a having a trench groove shape in which the first electrode 181 is disposed, and a first-B electrode arrangement groove 15b having a trench groove shape in which the second electrode 182 is disposed, are formed in the first molding space 13. A second molding space 16 is formed in the second mold 12 to face the first mold 11 and to correspond to the first molding space 13. A plurality of second pipe arrangement grooves 17 having a trench groove shape in which the plurality of main pipe portions 111 are respectively arranged, a second-A electrode arrangement groove 18a having a trench groove shape in which the first electrode 181 is disposed, and a second-B electrode arrangement groove 18b having a trench groove shape in which the second electrode 182 is disposed, are formed in the second molding space 16. An injection fluid injection path 19 through which the injection fluid is injected into the second molding space 16, is provided in the second mold 12.

In the insert installation operation (S20), in a state in which the mold 10 deformed through the mold preparation operation (S10) is prepared, the plurality of main pipe portions 111 and the first and second electrodes 181 and 182 that are inserts are installed on the mold 10, as shown in FIG. 8. In the insert installation operation (S20), each of the plurality of main pipe portions 111 is installed to be in the correct position in each of the plurality of first pipe arrangement grooves 14 formed in the first mold 11, and the first electrode 181 is installed to be in the correction position in the first-A electrode arrangement groove 15a formed in the first mold 11, and the second electrode 182 is installed to be located in the first-B electrode arrangement groove 15b formed in the first mold 11. Although not shown, in the insert installation operation (S20), the plurality of main pipe portions 111 and the first and second electrodes 181 and 182 that are inserts are fixed by a fixing jig and are maintained in correct positions to be spaced apart from surfaces of the corresponding first pipe arrangement groove 14 and the first-A and first-B electrode arrangement grooves 15a and 15b. After the plurality of main pipe portions 111 and the first and second electrodes 181 and 182 that are inserts are fixed by a fixing jig and are maintained inside the mold 10 in correct positions through the insert installation operation (S20), the mold-combining operation (S30) is performed.

In the mold-combining operation (S30), in a state in which the plurality of main pipe portions 111 and the first and second electrodes 181 and 182 that are inserts are installed on the mold 10 through the insert installation operation (S20), the first mold 11 and the second mold 12 of the mold 10 are combined with each other so that a cavity 20 is formed in the mold 10, as shown in FIG. 9. The cavity 20 has a shape corresponding to the heat dissipation structure 120 shown in FIGS. 1 through 3. After the cavity 20 is formed in the mold 10 through the mold-combining operation (S30), the injection fluid injection operation (S40) is performed.

In the injection fluid injection operation (S40), as shown in FIG. 9, the injection fluid is injected into the cavity 20 installed by inserting the plurality of main pipe portions 111 and the first and second electrodes 181 and 182 that are inserts, through the injection fluid injection path 19. The injection fluid that is a liquid composite material including a resin material and a carbon material is the material of the heat dissipation structure 120, as described above. As shown in FIGS. 10 and 11, an injection fluid C is filled in the cavity 20 of the mold 10 and is molded in a shape in which the connection pipes 116 are excluded from the heat exchanger 100 of FIGS. 1 through 3. After the thing having the shape excluding the connection pipe s116 is manufactured, a connection pipe-combining operation (S50) is performed, the connection pipes 116 are combined so that the heat exchanger 100 is completed. In the present embodiment, it will be described that the connection pipes 116 are combined after insert insertion molding is performed, however, unlike this, the pipe structure 110 having a completed shape including the connection pipes 116 is inserted through the insert installation operation (S20) so that insert injection molding may also be performed, and this also belongs to the scope of the present invention.

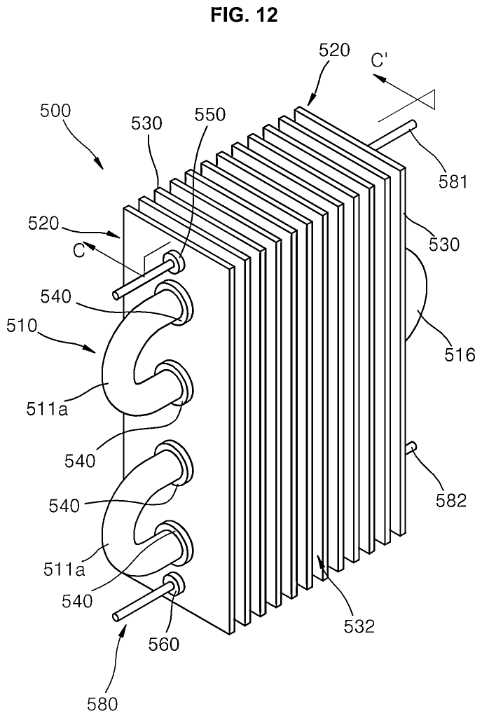

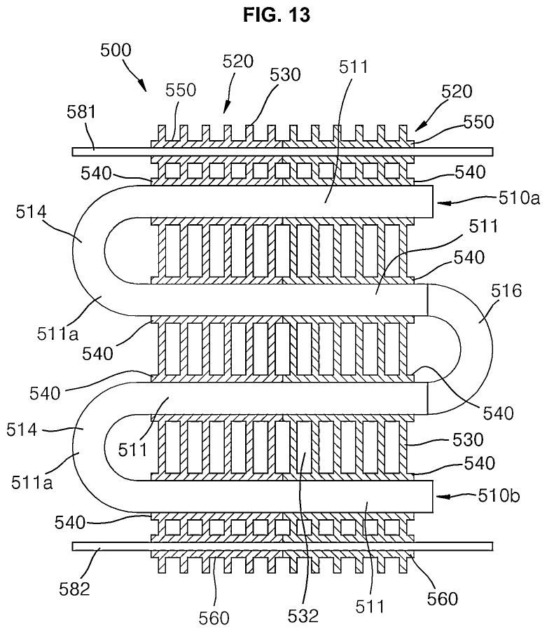

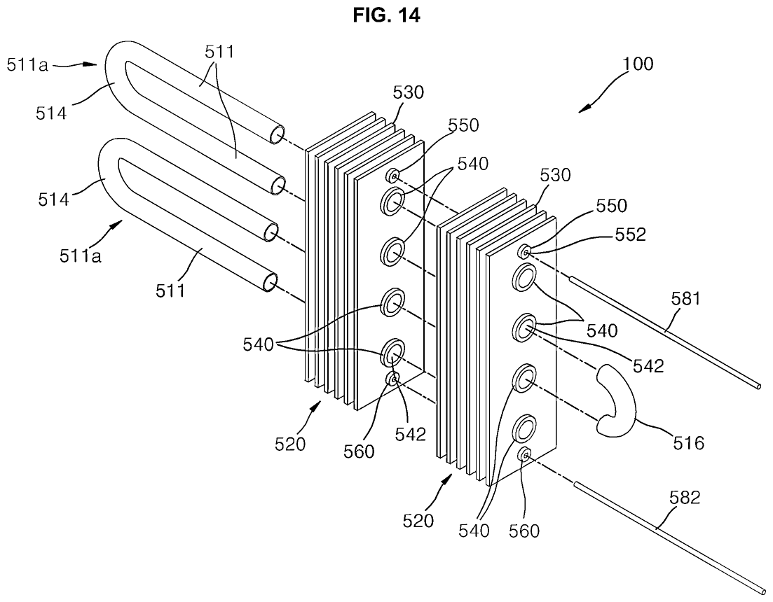

FIG. 12 is a perspective view of a heat exchanger according to another embodiment of the present invention. Referring to FIG. 12, a heat exchanger 500 according to another embodiment of the present invention includes a pipe structure 510, an electrode structure 580, and two heat dissipation structures 520 in which the pipe structure 510 and the electrode structure 580 are combined with each other. FIG. 13 is a cross-sectional view of a heat dissipation structure 520 of the heat exchanger 500 shown in FIG. 1, taken along a line C-C′ of FIG. 12. FIG. 14 is an exploded perspective view of the heat exchanger 500 shown in FIG. 12.

Referring to FIGS. 12, 13, and 14, the pipe structure 510 includes two main tubes 511a and a connection pipe portion 516 connecting between two main tubes 511a. The pipe structure 510 forms one flow path, and a fluid to be cooled by the heat exchanger 500 such as a refrigerant flows through the pipe structure 510. Heat of the refrigerant flowing through the pipe structure 510 is transferred to the heat dissipation structure 120. Each of both ends in the extension direction of the pipe structure 510 form a refrigerant inlet 510a and a refrigerant outlet 510b. In the present embodiment, it will be described that the pipe structure 510 is a copper pipe made of a copper material having excellent thermal conductivity generally used in a heat exchanger, but the present invention is not limited thereto.

The main tubes 511a include two main tubes 511 arranged in parallel, and a connection portion 514 connecting the two main tubes 511.

The two main pipe portions 511 is extended in parallel in a straight line in a state in which they are arranged in parallel. Adjacent ends of each of the two main pipe portions 511 are connected to each other by the connection portion 514. The two main pipe portions 511 are firmly combined to two heat dissipation structures 520.

The connection portion 514 connects the adjacent ends of each of the two main pipe portions 511. The connection portion 514 has generally a ‘U’ shape and allows the two main pipe portions 511 to communicate with each other.

In the present embodiment, it will be described that the main tube 511a is formed by bending processing one pipe material.

Two main tubes 511a are arranged so that all main pipe portions 511 are extended in parallel and each connection portion 514 is located in the same direction. The two main tubes 511a are connected to each other by the connection pipe portion 516 and communicate with each other.

The connection pipe portion 516 connects the two main tubes 511a to communicate with each other. The connection pipe portion 516 has generally a ‘U’ shape, and both ends of the connection pipe portion 516 are connected to the opened main pipe portion 511 of each of the two main tubes 511a. The two main tubes 511a communicate with each other by the connection pipe portion 516 and constitute the pipe structure 510.

In the present embodiment, it will be described that the pipe structure 510 is formed by connecting two main tubes 511a to each other using one connection pipe portion 516, but the present invention is not limited thereto. One or three or more main tubes 511a may be used, and this also belongs to the scope of the present invention. When one main tube 511a is used, the pipe structure 510 is configured without the connection pipe portion 516. When three or more main tubes 511a are used, one less connection pipe portion 516 than the main tubes 511a is used so that the pipe structure 510 is configured.

In the present embodiment, it will be described that the main tube 511a that is the component of the pipe structure 510 is formed by bending processing one pipe material, however, unlike this, the main tube 511a may be formed by connecting two tubes corresponding to the main pipe portion 511 using a separate pipe material such as the connection pipe portion 516, and this also belongs to the scope of the present invention.

The electrode structure 580 includes a first electrode 581 and a second electrode 582. The first electrode 581 has the shape of a line or rod having electrical conductivity that is extended long, and the first electrode 581 and the second electrode 582 are installed in the heat dissipation structure 520. The first electrode 581 and the second electrode 582 are located at opposite sides with the pipe structure 510 therebetween. The first electrode 581 and the second electrode 582 are extended in parallel to the main pipe tubes 511 of the pipe structure 510. A voltage difference between the first electrode 581 and the second electrode 582 is generated by an external power, and due to the voltage difference between the first electrode 581 and the second electrode 582, the heat dissipation structure 520 dissipates heat, and frost attached to the heat dissipation structure 520 may be melted and removed in a refrigerant cooling process of the heat exchanger 500.

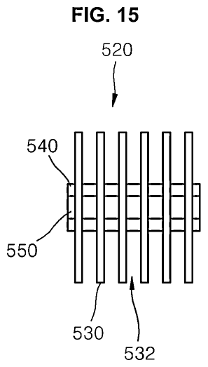

Two heat dissipation structures 520 are sequentially arranged in the extension direction of the main pipe portion 511 provided in the pipe structure 510 and are continuously connected to each other. In the present embodiment, it will be described that two heat dissipation structures 520, however, unlike this, one or three or more heat dissipation structures may be sequentially arranged, and this also belongs to the scope of the present invention. The heat dissipation structure 520 is combined with the pipe structure 510 and dissipates heat of the refrigerant flowing through the pipe structure 510. Heat exchanging between heat of the refrigerant flowing through the pipe structure 510 and air around the heat dissipation structure 520 is performed through the heat dissipation structure 520. The heat dissipation structure 520 is made of a composite material including generally a resin material and a carbon material. The carbon material of the composite material that constitutes the material of the heat dissipation structure 520 includes at least one of carbon fiber, carbon nanotube, and graphene. The carbon material of the composite material is distributed into the resin material and forms an electrical network. The length of the carbon material is 1 to 100 μm, and the content of carbon materials is 5 w % or more and 25 w % or less so as to form the electrical network. It will be described that carbon nanotube (CNT) is used for the carbon material. The composite material that constitutes the heat dissipation structure 520 may further include an additive such as a metal powder for improving thermal conductivity. The additive is interposed between carbon materials, increases the electrical network by the carbon materials and simultaneously increases thermal conductivity of the heat dissipation structure 520. In the present embodiment, the additive is a metal powder and has a diameter of 10 nm to 100 nm, and the content of the metal powder is 12 w % or more so as to increase the electrical network between the carbon materials and to increase thermal conductivity of the composite material and 30 w % or less so as to reduce the weight of the composite material. In the present embodiment, it will be described that an aluminum powder is used for the additive, will be described. FIG. 15 is a plan view of the heat dissipation structure 520.

Referring to FIGS. 12 through 15, the heat dissipation structure 520 includes a plurality of heat dissipation fin portions 530, a plurality of pipe combination portions 540 that connect two adjacent heat dissipation fin portions 530 to each other while surrounding the plurality of main pipe portions 511 of the pipe structure 510, a first electrode combination portion 550 that connects two adjacent heat dissipation fin portions 530 structurally while surrounding the first electrode 581, and a second electrode combination portion 560 that connects two adjacent heat dissipation fin portions 530 while surrounding the second electrode 582.

Each of the plurality of heat dissipation fin portions 530 is a plate-shaped bar shape that is extended long in an arrangement direction (a vertical direction in FIG. 13) of the plurality of main pipe portions 511 of the pipe structure 510. Each of the plurality of heat dissipation fin portions 530 is arranged to form generally a right angle to the extension direction of the main pipe portion 511 of the pipe structure 510. The plurality of heat dissipation fin portions 530 are sequentially arranged in a line in the extension direction of the main pipe portion 511 of the pipe structure 510. Thus, the main pipe portions 511 of the pipe structure 510 penetrates the heat dissipation fin portion 530 at generally a right angle. Each of the plurality of heat dissipation fin portions 530 is spaced apart from another adjacent heat dissipation fin portion 530 so that a path 532 through which the air may flow, is formed between two adjacent heat dissipation fin portions 530. Heat exchanging between heat of the refrigerant flowing through the pipe structure 510 and the air flowing through the path 532 is performed by the heat dissipation fin portion 530. Each of the plurality of main pipe portions 511 of the pipe structure 510 passes each of the plurality of heat dissipation fin portions 530 so as to form generally a right angle to each other. The heat dissipation fin portion 530 is in close contact with an outer circumferential surface of the main pipe portion 511 at a portion coupled to the main pipe portion 511 of the pipe structure 510. Two adjacent heat dissipation fin portions 530 among the plurality of heat dissipation fin portions 530 are structurally connected to each other by the plurality of pipe combination portions 540, the first electrode combination portion 550, and the second electrode combination portion 560. In the present embodiment, it will be described that the heat dissipation fin portion 530 has a flat plate shape, will be described, however, unlike this, the heat dissipation fin portion 530 may have a shape with a curvature in which at least a part of the heat dissipation fin portion 530 can be injected, and this also belongs to the scope of the present invention.

Each of the plurality of pipe combination portions 540 connects two adjacent heat dissipation fin portions 530 structurally while surrounding the plurality of main pipe portions 511 of the pipe structure 510. Each of the plurality of pipe combination portions 540 is extended in a straight line to pass the plurality of heat dissipation fin portions 530 sequentially. The plurality of pipe combination portions 540 is extended in parallel. A tube path 542 through which the main pipe portions 511 of the pipe structure 510 pass one by one, is formed in each of the plurality of pipe combination portions 540. In the present embodiment, it will be described that four pipe combination portions 540 are provided to correspond to the main pipe portions 511 of the pipe structure 510. The plurality of pipe combination portions 540 are integrally connected to two adjacent heat dissipation fin portions 530. The inner circumferential surface of the pipe combination portion 540 is in close contact with the outer circumferential surface of the main pipe portion 511 of the pipe structure 510, and combination between the pipe structure 510 and the heat dissipation structure 520 becomes firm so that heat transfer from the pipe structure 510 to the heat dissipation structure 520 can be efficiently performed. In the present embodiment, it will be described that the pipe structure 510 is not exposed from the heat dissipation structure 520 by the pipe combination portion 540, however, unlike this, the pipe combination portion 540 may be extended short from the heat dissipation fin portion 530 or the pipe combination portion 540 may not be formed so that the pipe structure 520 can be exposed between the two adjacent heat dissipation fin portions 530, and this also belongs to the scope of the present invention.

The first electrode combination portion 550 connects the two adjacent heat dissipation fin portions 530 structurally while surrounding the first electrode 581. The first electrode combination portion 550 is extended in a straight line to pass the plurality of heat dissipation fin portions 530 sequentially. The first electrode combination portion 550 is located adjacent to a first end (upper end in FIG. 13) in the lengthwise direction of the heat dissipation fin portion 530. The first electrode combination portion 550 is integrally connected to the two adjacent heat dissipation fin portions 530. A first electrode path 552 through which the first electrode 581 passes, is formed on the first electrode combination portion 550. The inner circumferential surface of the first electrode combination portion 550 is in close contact with the outer circumference of the first electrode 581.

The second electrode combination portion 560 connects the two adjacent heat dissipation fin portions 530 structurally while surrounding the second electrode 582. The second electrode combination portion 560 is extended in a straight line to pass the plurality of heat dissipation fin portions 530 sequentially. The second electrode combination portion 560 is located adjacent to a second end (lower end in FIG. 13) in the lengthwise direction of the heat dissipation fin portion 530. The second electrode combination portion 560 is integrally connected to the two adjacent heat dissipation fin portions 530. A second electrode path 562 through which the second electrode 582 passes, is formed on the second electrode combination portion 560. The inner circumferential surface of the second electrode combination portion 560 is in close contact with the outer circumference of the second electrode 582.

A plurality of pipe combination portions 540 are arranged between the first electrode combination portion 550 and the second electrode combination portion 560.

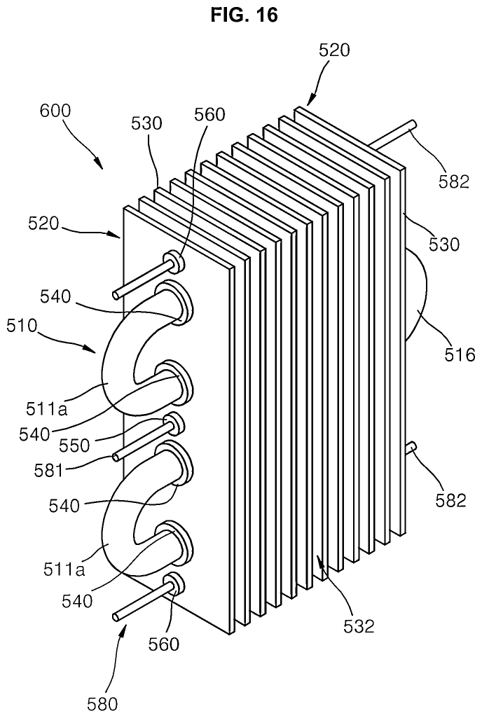

In the present embodiment, it will be described that each of one first electrode 581 and one second electrode 582 is located adjacent to both ends of the heat dissipation fin portion 530, however, the present invention is not limited thereto. As shown in FIG. 16, in the heat exchanger 600, one first electrode 581 may be combined with the first electrode combination portion 550 and may be located in the middle in the extension direction (height direction in the drawing) of the heat dissipation fin portion 530, and two second electrodes 582 may be located adjacent to both ends of the heat dissipation fin portion 530 and may be combined with the second electrode combination portion 560. In this case, a distance between the first electrode 581 and the second electrode 582 is reduced so that the performance can be improved.

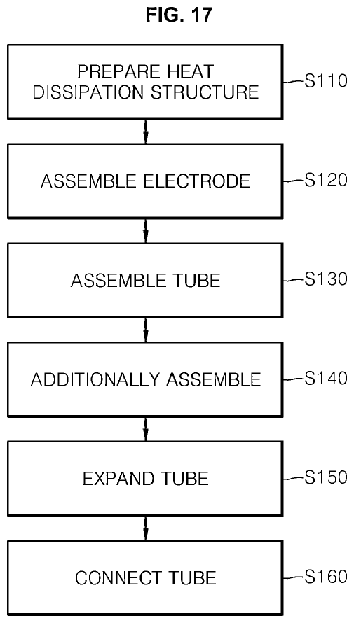

FIG. 17 is a flowchart schematically illustrating a method for manufacturing a heat exchanger according to another embodiment of the present invention. The method for manufacturing a heat exchanger shown in FIG. 17 is used to manufacture the heat exchanger 500 described above with reference to FIGS. 12 through 15. Referring to FIG. 17, the method for manufacturing the heat exchanger includes a heat dissipation structure preparation operation (S110) in which a heat dissipation structure 500 is prepared, an electrode assembly operation (S120) in which a first electrode 581 and a second electrode 582 are assembled to the heat dissipation structure 520, a tube assembly operation (S130) in which a plurality of main pipe portions 511 are assembled to the heat dissipation structure 520, an additional assembly operation (S140) in which the heat dissipation structure 520 is additionally assembled, a tube expansion operation (S150) in which the outer diameter of the plurality of main pipe portions 511 assembled to the heat dissipation structure 520 is increased, and a tube connection operation (S160) in which the plurality of main pipe portions 511 assembled to the heat dissipation structure 520 are connected to each other.

In the heat dissipation structure preparation operation (S110), a heat dissipation structure 520 having the configuration described above with reference to FIGS. 12 through 15 is prepared. The heat dissipation structure 520 is manufactured by injection molding, and a first electrode path 552 of the heat dissipation structure 520 has a size at which the first electrode 581 may be inserted, a second electrode path 562 has a size at which the second electrode 582 may be inserted, and the tube path 542 has a size at which the main pipe portion 511 may be inserted. In the heat dissipation structure preparation operation (S110), the heat dissipation structure 520 is prepared as many as needed. As shown in the embodiment of FIG. 12, when two heat dissipation structures 520 are used, the two heat dissipation structures 520 are prepared. After the heat dissipation structure 520 is prepared as many as needed through the heat dissipation structure preparation operation (S110), the electrode assembly operation (S120) is performed.

In the electrode assembly operation (S120), the first electrode 581 and the second electrode 582 are assembled to and fixed to one heat dissipation structure 520 among the heat dissipation structures 520 prepared through the heat dissipation structure preparation operation (S110). The electrode assembly operation (S120) is performed by inserting the first electrode 581 into the first electrode path 552 of the heat dissipation structure 520 and by inserting the second electrode 582 into the second electrode path 562 of the heat dissipation structure 520. The first electrode 581 and the second electrode 582 may be fixed to the heat dissipation structure 520 using a fixing unit such as an adhesive. FIG. 7 illustrates a state in which the electrode assembly operation (S120) is performed and the first electrode 581 and the second electrode 582 are assembled to and fixed to the heat dissipation structure 520. After the first electrode 581 and the second electrode 582 are assembled to the heat dissipation structure 520 through the electrode assembly operation (S120), the tube assembly operation (S130) is performed.

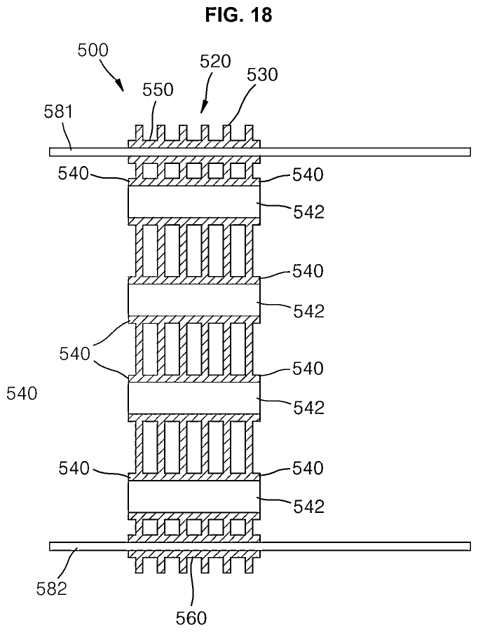

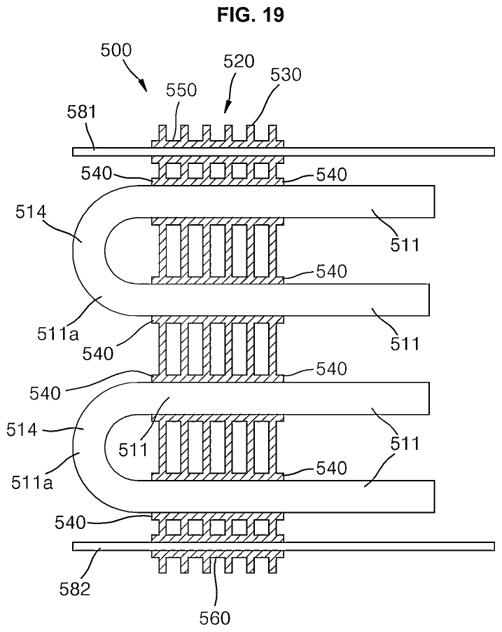

In the tube assembly operation (S130), a plurality of main pipe portions 511 are assembled to the heat dissipation structure 520. The tube assembly operation (S130) may be performed by assembling two main tubes 511a to one heat dissipation structure 520 in which the first electrode 581 and the second electrode 582 are assembled to each other, as shown in FIG. 18. Two main pipe portions 511 provided on one main tube 511a are respectively inserted into two adjacent upper tube paths 542 among four tube paths 542 formed on the heat dissipation structure 520, and two main pipe portions 511 provided on the other main tube 511a are respectively inserted into two remaining lower tube paths 542. In this case, ends of each of the two main tubes 511a face the same direction. FIG. 19 illustrates a state in which the tube assembly operation (S130) is performed and two main tubes 511a are assembled to the heat dissipation structure 520. After the main tube portions 511 are assembled to the heat dissipation structure 520 through the tube assembly operation (S130), the additional assembly operation (S140) is performed.

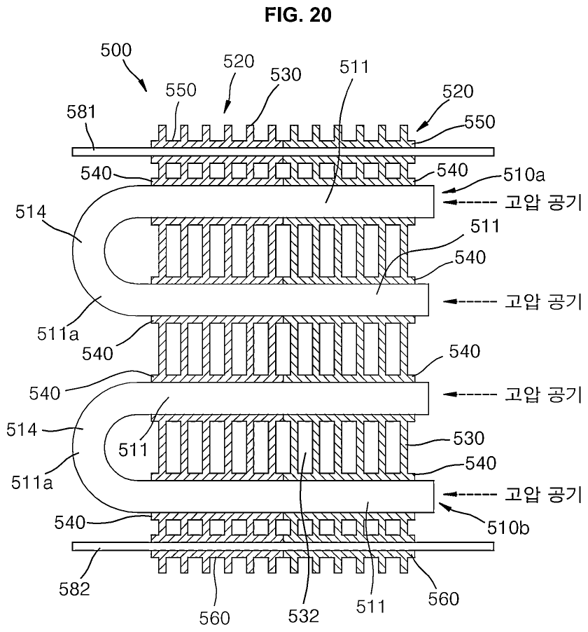

In the additional assembly operation (S140), the heat dissipation structure 520 is additionally assembled. The additional assembly operation (S140) is performed, in the state shown in FIG. 19, by assembling the additional heat dissipation structure 520 to two main tubes 511a in the same manner as in the tube assembly operation (S130). FIG. 20 illustrates a state in which the additional assembly operation (S140) is performed and two heat dissipation structures 520 are assembled. As shown in FIG. 20, an opened end of each of the plurality of main pipe portions 511 protrudes from the outside of the heat dissipation structure 520 in the same direction. In the additional assembly operation (S140), two or more heat dissipation structures 520 may be additionally assembled. After the additional assembly operation (S140) is performed, the tube expansion operation (S150) is performed.

In the tube expansion operation (S150), the outer diameter of the plurality of main pipe portions 511 assembled to the heat dissipation structures 520 is increases so that the inner circumferential surface of the pipe combination portion 540 provided on the heat dissipation structure 520 and the outer circumferential surface of the main pipe portion 511 are in close contact with each other. The tube expansion operation (S150) may be performed by injecting high-pressure air into the main pipe portion 511, as shown in FIG. 20, through the opened end of the main pipe portions 511. The main pipe portion 511 is plastically deformed and expanded by the high-pressure air flowing into the main pipe portion 511.

In the tube connection operation (S160), the plurality of main pipe portions 511 assembled to the heat dissipation structure 520 are connected to form one path. The tube connection operation (S160) is performed by connecting each opening of two adjacent middle main pipe portions 511 in the state shown in FIG. 19 to the connection pipe portion 516 using a method such as welding.

In the present embodiment, the electrode assembly operation (S120) is performed before the tube assembly operation (S130) is performed, however, the present invention is not limited thereto. The electrode assembly operation (S120) may be performed even after the tube assembly operation (S130), or the additional assembly operation (S140), or after the tube expansion operation (S150), or the tube connection operation (S160), and this also belongs to the scope of the present invention.

In the present embodiment, the method shown in FIG. 17 has been described to manufacture the heat exchanger 500 shown in FIGS. 12 through 15, however, may also be applied to manufacture the heat exchanger 600 shown in FIG. 16.

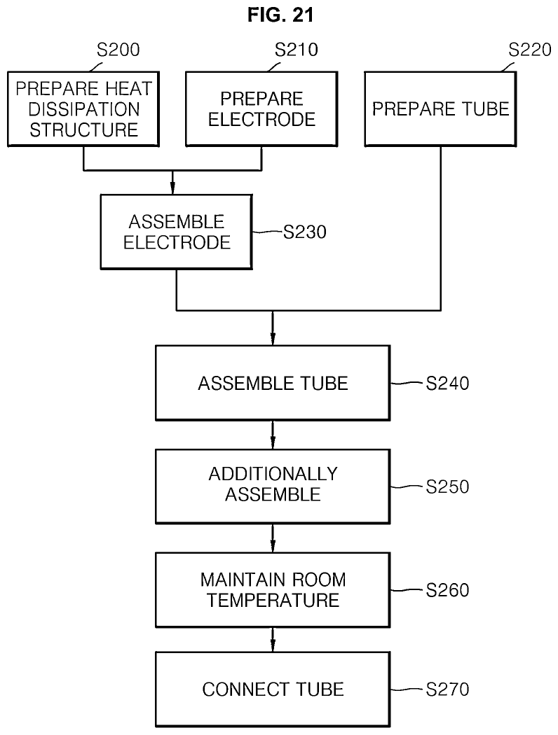

FIG. 21 is a flowchart schematically illustrating a method for manufacturing a heat exchanger according to another embodiment of the present invention. The method for manufacturing a heat exchanger shown in FIG. 21 is used to manufacture the heat exchangers 500 and 600 described above with reference to FIGS. 12 through 16. Referring to FIG. 21, the method for manufacturing the heat exchanger includes a heat dissipation structure preparation operation (S200) in which a heat dissipation structure 520 is prepared, an electrode preparation operation (S210) in which a first electrode 581 and a second electrode 582 are prepared, a tube preparation operation (S220) in which a plurality of main pipe portions 511 are prepared, an electrode assembly operation (S230) in which the first electrode 581 and the second electrode 582 are assembled to each other, a tube assembly operation (S240) in which the plurality of main pipe portions 511 are assembled to the heat dissipation structure 520, an additional assembly operation (S250) in which the heat dissipation structure 520 is additionally assembled to each other, a room temperature maintenance operation (S260) in which the two electrodes 581 and 582 and the plurality of main pipe portions 511 are in close contact with the heat dissipation structure 520 at the room temperature, and a tube connection operation (S270) in which the plurality of main pipe portions 511 assembled to the heat dissipation structure 520 are connected to each other.

In the heat dissipation structure preparation operation (S200), the heat dissipation structure 520 having the configuration described above with reference to FIGS. 12 through 15 is prepared. The heat dissipation structure 520 is manufactured by injection molding, and a first electrode path 552 has a size at which the first electrode 581 may be inserted, a second electrode path 562 has a size at which the second electrode 582 may be inserted, and a tube path 542 has a size at which the main pipe portion 511 may be inserted. In the heat dissipation structure preparation operation (S200), the heat dissipation structure 520 is prepared as many as needed. The heat dissipation structure 520 prepared in the heat dissipation structure preparation operation (S200) is high-temperature treated, and is in an expanded state than in the room temperature through high-temperature treatment. As shown in the embodiment of FIG. 12, when two heat dissipation structures 520 are used, two heat dissipation structures 520 are prepared.

In the electrode preparation operation (S210), the first electrode 581 and the second electrode 582 having the configuration described above with reference to FIGS. 12 through 15 are prepared. The first electrode 581 and the second electrode 582 prepared in the electrode preparation operation (S210) are low-temperature treated and are in a contracted state than in the room temperature through low-temperature treatment. Thus, the outer diameter of the first electrode 581 is less than the inner diameter of the first electrode path 552 of the heat dissipation structure 520 prepared in the heat dissipation structure preparation operation (S200), and the outer diameter of the second electrode 582 prepared through the electrode preparation operation (S210) is less than the inner diameter of the second electrode path 562 of the heat dissipation structure 520 prepared through the heat dissipation structure preparation operation (S200).

In the tube preparation operation (S220), a plurality of main pipe portions 511 are prepared. The tube preparation operation (S220) may be performed by preparing main tubes 511a having the configuration described above with reference to FIGS. 12 through 15. The main tubes 511a prepared in the tube preparation operation (S220) are low-temperature treated and are in a contracted state than in the room temperature through low-temperature treatment. Thus, each of the plurality of main pipe portions 511 prepared through the tube preparation operation (S220) has a smaller inner diameter than the inner diameter of the tube path 542 of the heat dissipation structure 520 prepared through the heat dissipation structure preparation operation (S200).

In the electrode assembly operation (S230), the first electrode 581 and the second electrode 582 are assembled to the heat dissipation structure 520. The electrode assembly operation (S230) is performed by inserting the first electrode 581 and the second electrode 582 prepared through the electrode preparation operation (S210) into the first electrode path 552 and the second electrode path 562 of the heat dissipation structure 520, respectively, prepared through the heat dissipation structure preparation operation (S200). The inner diameters of the first electrode path 552 and the second electrode path 562 of the heat dissipation structure 520 prepared through the heat dissipation structure preparation operation (S200) are greater than the outer diameters of the first electrode 581 and the second electrode 582 prepared through the electrode preparation operation (S210) and thus, the electrode assembly operation (S230) is easily performed.

In the tube assembly operation (S240), a plurality of main pipe portions 511 are assembled to the heat dissipation structure 520. The tube assembly operation (S240) is performed by inserting two main pipe portions 511 of each of the main tubes 511a prepared through the tube preparation operation (S220) into each of the tube paths 542 of the heat dissipation structure 520 prepared through the heat dissipation structure preparation operation (S200). The inner diameters of the tube paths 542 of the heat dissipation structure 520 prepared through the heat dissipation structure preparation operation (S200) are greater than the outer diameters of the main pipe portions 511 of each of the main tubes 511a prepared through the tube predation operation (S220) and thus, the tube assembly operation (S240) is easily performed.

In the additional assembly operation (S250), the heat dissipation structure 520 is additionally assembled. The additional assembly operation (S250) is performed in generally the same manner as in the additional assembly operation (S140) of FIG. 17.

In the room temperature maintenance operation (S260), an assembly body in which the additional assembly operation (S250) is performed, is maintained for a predetermined amount of time in a room temperature environment so that two electrodes 581 and 582 and the plurality of main pipe portions 511 are in close contact with the heat dissipation structure 520. The heat dissipation structure 520 prepared through the heat dissipation structure preparation operation (S200) in the room temperature environment is contracted into an original state, and the two electrodes 581 and 582 prepared through the electrode preparation operation (S210) and the main tubes 511a prepared through the tube preparation operation (S220) are expanded into original states.

In the tube connection operation (S270), the plurality of main pipe portions 511 assembled to the heat dissipation structure 520 are connected to each other to form one path. The tube connection operation (S270) is performed in generally the same manner as in the tube connection operation (S160) of FIG. 17.

In the present embodiment, the method shown in FIG. 21 has been described to manufacture the heat exchanger 500 shown in FIGS. 12 through 15, however, may also be applied to manufacture the heat exchanger 600 shown in FIG. 16.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A heat exchanger comprising:
a pipe structure having an inlet and an outlet formed therein and providing a flow path which is extended between the inlet and the outlet and through which a refrigerant flows; and
a heat dissipation structure coupled to the pipe structure to exchange heat between the refrigerant and an external fluid,
wherein the heat dissipation structure is made of a composite material comprising a resin material and a carbon material.

2. The heat exchanger of claim 1, wherein the carbon material comprises at least one of carbon fiber, carbon nanotube, and graphene, which is dispersed into the resin material and constitutes a network.

3. The heat exchanger of claim 1, wherein the heat dissipation structure comprises a plurality of heat dissipation fin portions arranged so that the pipe structure penetrates sequentially and passes the plurality of heat dissipation fin portions, and a pipe combination portion connecting two adjacent heat dissipation fin portions among the plurality of heat dissipation fin portions to surround the pipe structure.

4. The heat exchanger of claim 3, further comprising an electrode structure comprising a first electrode and a second electrode electrically connected to the heat dissipation structure, wherein the heat dissipation structure further comprises a first connection portion connected to a first end of each of the plurality of heat dissipation fin portions and a second connection portion connected to a second end of each of the plurality of heat dissipation fin portions, and the first electrode is installed at the first connection portion, and the second electrode is installed at the second connection portion.

5. The heat exchanger of claim 4, wherein the first connection portion comprises a first connection plate formed to generally cover a first end of each of the plurality of heat dissipation fin portions, and the second connection portion comprises a second connection plate formed to generally cover a second end of each of the plurality of heat dissipation fin portions.

6. The heat exchanger of claim 1, wherein the pipe structure comprises a plurality of main pipe portions arranged in parallel and passing the heat dissipation structure, and a connection pipe portion connecting two adjacent main pipe portions among the plurality of main pipe portions.

7. (canceled)

8. A method for manufacturing a heat exchanger, the heat exchanger comprising a pipe structure having an inlet and an outlet formed therein and providing a flow path which is extended between the inlet and the outlet and through which a refrigerant flows and a heat dissipation structure coupled to the pipe structure to exchange heat between the refrigerant and an external fluid, the method comprising:
a mold preparation operation in which a first mold and a second mold are prepared to be combined with each other and to form a cavity corresponding to a shape of the heat dissipation structure;
an insert installation operation in which, before the first mold and the second mold are combined with each other, an insert including at least a part of the heat dissipation structure is installed in the middle corresponding to the cavity;
a mold-combining operation in which the first mold and the second mold are combined with each other to form the cavity and the insert is disposed in the cavity; and
an injection fluid injection operation in which an injection fluid is injected into the cavity,
wherein the injection fluid comprises a liquid resin material including a carbon material.

9. The method of claim 8, wherein the insert further comprises a first electrode and a second electrode.

10. A method for manufacturing a heat exchanger, the method comprising:
a heat dissipation structure preparation operation in which a heat dissipation structure made of a composite material including a resin material and a carbon material is prepared;
an electrode assembly operation in which a first electrode and a second electrode are assembled to the heat dissipation structure; and
a tube assembly operation in which a main pipe portion on which a fluid to be heat-exchanged flows, is assembled to the heat dissipation structure,
wherein the tube assembly operation is performed by inserting the main pipe portion into a tube path formed on the heat dissipation structure.

11. The method of claim 10, wherein the electrode assembly operation is performed by inserting the first electrode and the second electrode into a first electrode path and a second electrode path formed on the heat dissipation structure, respectively.

12. The method of claim 10, further comprising an additional assembly operation in which at least one additional heat dissipation structure is further assembled to the main pipe portion after the tube assembly operation is performed, wherein the additional heat dissipation structure and the heat dissipation structure assembled in the tube assembly operation are sequentially and continuously arranged in an extension direction of the main pipe portion.

13. The method of claim 10, wherein a main tube comprising the two main pipe portions arranged in parallel and a connection portion connecting the two main pipe portions is used in the tube assembly operation.

14. The method of claim 13, wherein a plurality of main tubes are arranged in parallel and assembled to the heat dissipation structure in the tube assembly operation.

15. The method of claim 14, further comprising a tube connection operation in which the plurality of main tubes are connected to each other using a connection pipe portion.

16. The method of claim 10, further comprising:
an electrode preparation operation in which the first electrode and the second electrode are prepared;
a tube preparation operation in which the main pipe portion is prepared; and
a room temperature maintenance operation in which the first electrode, the second electrode and the main pipe portion are maintained at room temperature while they are assembled to the heat dissipation structure,
wherein, in the heat dissipation structure preparation operation, the heat dissipation structure is high-temperature treated and is prepared in an expanded state, and
in the electrode preparation operation, the first electrode and the second electrode are low-temperature treated and are prepared in a contracted state, and
in the tube preparation operation, the main pipe portion is low-temperature treated and is prepared in a contracted state, and
the electrode assembly operation is performed by inserting the first electrode and the second electrode into a first electrode path and a first electrode path formed on the heat dissipation structure, respectively, and
in the room temperature maintenance operation, the heat dissipation structure is contracted into an original state, and the first electrode, the second electrode, and the main pipe portion are contracted into original states.

17. The method of claim 16, further comprising, after the tube assembly operation is performed and before the room temperature maintenance operation is performed, an additional assembly operation in which at least one additional heat dissipation structure is further assembled to the main pipe portion.

18. The method of claim 16, wherein a main tube comprising the two main pipe portions arranged in parallel and a connection portion connecting the two main pipe portions is used in the tube assembly operation.

19. The method of claim 18, wherein a plurality of main tubes are arranged in parallel and assembled to the heat dissipation structure in the tube assembly operation.

20. The method of claim 19, further comprising a tube connection operation in which the plurality of main tubes are connected to each other using a connection pipe portion.

21. The method of claim 10, further comprising a tube expansion operation in which the main pipe portion is plastically deformed to be expanded, wherein the tube expansion operation is performed by injecting a high-pressure air into the main pipe portion.
